(19) United States
(12) Patent Application Publication
(10) Pub. No.: US 2017/0298593 A1
(43) Pub. Date: Oct. 19, 2017

(54) VIBRATORY CABLE PLOW

(71) Applicant: VERMEER MANUFACTURING COMPANY, PELLA, IA (US)

(72) Inventors: TYLER J. DORIN, 4899 ORCHARD DRIVE, IA (US); RANDY RUNQUIST, KNOXVILLE, IA (US); JACOB R. SMITH, ANKENY, IA (US)

(73) Assignee: VERMEER MANUFACTURING COMPANY, PELLA, IA (US)

(21) Appl. No.: 15/509,794

(22) PCT Filed: Sep. 8, 2015
(86) PCT No.: PCT/US2015/048950

§ 371 Date: Mar. 8, 2017

Related U.S. Application Data
(60) Provisional application No. 62/047,224, filed on Sep. 8, 2014.

(51) Int. Cl. E02F 5/14; E02F 5/02; E02F 5/10; F16F 3/10

(52) U.S. Cl. CPC E02F 5/14; E02F 5/103; E02F 5/027; F16F 3/10

(57) ABSTRACT

A vibratory plow has a lift bracket. The lift bracket couples to an upper link by an upper spring having an upper energy absorptive member. The upper spring and upper energy absorptive member are configured to limit upper link movement relative to the lift bracket in a first direction. The lift bracket is coupled to the upper link by a lower spring having a lower energy absorptive member; the lower spring and lower energy absorptive member are configured to limit upper link movement relative to the lift bracket in a direction opposite the first direction. The upper link is coupled to a shaker box which is attached to a plow blade. The shaker box is configured to travel from a baseline position a first distance greater than two inches in the first direction before the upper spring compresses enough that the upper energy absorptive member dampens shaker box movement.

### FIELD OF THE INVENTION

The invention relates generally to the field of plows for burying different types of cables and pipes into the ground without the need to excavate trenches. More specifically, the invention relates to vibratory cable plows.

### SUMMARY

A vibratory plow having a lift bracket, an upper link, and a lower link is disclosed according to one embodiment. The upper link is operably coupled to the lift bracket. An upper spring has an upper energy absorptive member associated therewith. The upper spring is adjacent the upper link. The upper spring and the upper energy absorptive member are collectively configured to limit relative movement of the upper link with respect to the lift bracket in a first direction. The plow includes a lower spring having a lower energy absorptive member associated therewith. The lower spring is adjacent the upper link. The lower spring and the lower energy absorptive member are collectively configured to limit the relative movement of the upper link with respect to the lift bracket in a second direction opposite the first direction. The plow comprises a shaker box that is operably coupled to the upper link and the lower link, and a plow blade that is attached to the shaker box. The shaker box is configured to travel from an initial baseline position a first distance in the first direction before the upper spring compresses to enable the upper energy absorptive member to dampen the movement of the shaker box. The first distance is greater than two inches.

According to another embodiment, a linkage system for use with a vibratory plow includes a vibrator tool assembly. A pull arm is provided for coupling a work machine to the tool assembly. The linkage system further includes a lift bracket. A first spring has a first energy absorptive member associated therewith, and a second spring has a second energy absorptive member associated therewith. The first spring and the first energy absorptive member collectively limit relative movement of the pull arm with respect to the lift bracket in a first direction. The second spring and the second energy absorptive member collectively limit relative movement of the pull arm with respect to the lift bracket in a second direction opposite the first direction. The pull arm is configured to allow the vibrator tool assembly to travel a first distance relative to the lift bracket from a static baseline position. The first distance is greater than two inches. The movement of the vibrator tool assembly to cover the first distance is undampened.

According to another embodiment, a work machine comprises a towing apparatus and a vibratory plow. The vibratory plow comprises a lift bracket, an upper link, and a lower link. The upper link has a top side and a bottom side, and is operably coupled to the lift bracket. The upper spring has an upper energy absorptive member associated therewith. The upper spring is adjacent the upper link and in contact with the top side. The upper spring and the upper energy absorptive member are collectively configured to limit relative movement of the upper link with respect to the lift bracket in a first direction. The plow includes a lower spring having a lower energy absorptive member associated therewith. The lower spring is adjacent the upper link and in contact with the bottom side. The lower spring and the lower energy absorptive member are collectively configured to limit the relative movement of the upper link with respect to the lift bracket in a second direction opposite the first direction. The plow comprises a shaker box that is operably coupled to the upper link and the lower link, and a plow blade that is attached to the shaker box. The shaker box is configured to travel from an initial baseline position a first distance in the first direction before the upper spring compresses to such an extent so as enable the upper energy absorptive member to dampen the movement of the shaker box. The first distance is greater than two inches. The vibratory plow is coupled to the towing apparatus.

According to yet another embodiment, a method of increasing an efficiency of a vibratory plow by decreasing a drawbar force required to pull a blade of the plow through the ground comprises the steps of providing a towing machine and a vibratory plow. The vibratory plow comprises a lift bracket, a pull arm, a spring, and an oscillating mechanism having the blade operably coupled to it. The pull arm is configured to move a first distance relative to the lift bracket in a first direction before an absorptive member associated with the spring contacts the pull arm. The first distance is greater than two inches.

### BRIEF DESCRIPTION OF THE SEVERAL VIEWS OF THE DRAWINGS

Illustrative embodiments of the present invention are described in detail below with reference to the attached drawing figures and wherein:

FIG. 1 is a schematic illustration of a prior art vibratory cable plow;

FIG. 1A is a schematic illustration of another prior art vibratory cable plow;

FIG. 2 is a schematic illustration of a typical vibration limiting device used in prior art cable plows;

FIG. 2A is a schematic illustration of yet another prior art vibratory cable plow;

FIG. 2B is a top view of an upper link of the prior art cable plow of FIG. 2

FIG. 3 is a schematic illustration of a vibratory cable plow, according to an embodiment of the present invention;

FIG. 4 is a schematic cutaway showing suspension components of the vibratory cable plow of FIG. 3 in additional detail;

FIG. 5 is a schematic cutaway showing springs and absorptive members of a vibration dampening mechanism of the plow of FIG. 3;

FIGS. 6A-6B are schematic illustrations showing undampened movement of a spring; and

FIG. 7 is a top view of an upper link of the plow of FIG. 3.

### DETAILED DESCRIPTION

Utility lines (e.g., fiber optic cables, electrical power cables, communication cables, natural gas lines, drip irrigation lines, drainage lines, et cetera) are often installed underground. For years, these utility lines were laid underground using a three step process. A powered trench digging machine was first used to form a trench of a desired depth for retaining the utility line. The utility line was then inserted along the bottom of the trench. And finally, the trench was filled, either by hand or another powered machine, to complete this time consuming installation process.

Cable plows were eventually developed to install utility lines underground in a single pass. Cable plows are generally coupled to the rear of a towing machine (e.g., a tractor or dozer), and have a blade that is dragged through the ground to create a narrow groove that typically collapses on itself without the need for backfilling. Cable plows further have apparatus (e.g., reels) for laying the utility line into the groove as the groove is formed.

A substantial amount of energy is required to pull a cable plow such that the blade of the cable plow creates a groove within the ground for installation of the utility line. This energy required to pull a cable plow through the ground depends on various factors, including the intended width and depth of the groove, the size and weight of the cable plow, the conditions of the soil, et cetera. As will be appreciated, for example, where the soil is hard, the process of burying the utility lines in the ground is slow and inefficient, as a large amount of power is required to cause the plow blade to form a groove in the hardened soil.

Various mechanisms have been employed in the prior art to reduce this loading of cable plows during operation. For example, liquid may be injected into the plow blade and the utility line being installed to moisten and soften the ground. Or, for example, in the case of vibratory plows, rotating masses within a shaker box may be utilized to impart vibratory motion to the plow in a generally vertical direction, which, as is known, reduces the drawbar forces required to drag the plow blade through the ground in a generally horizontal direction.

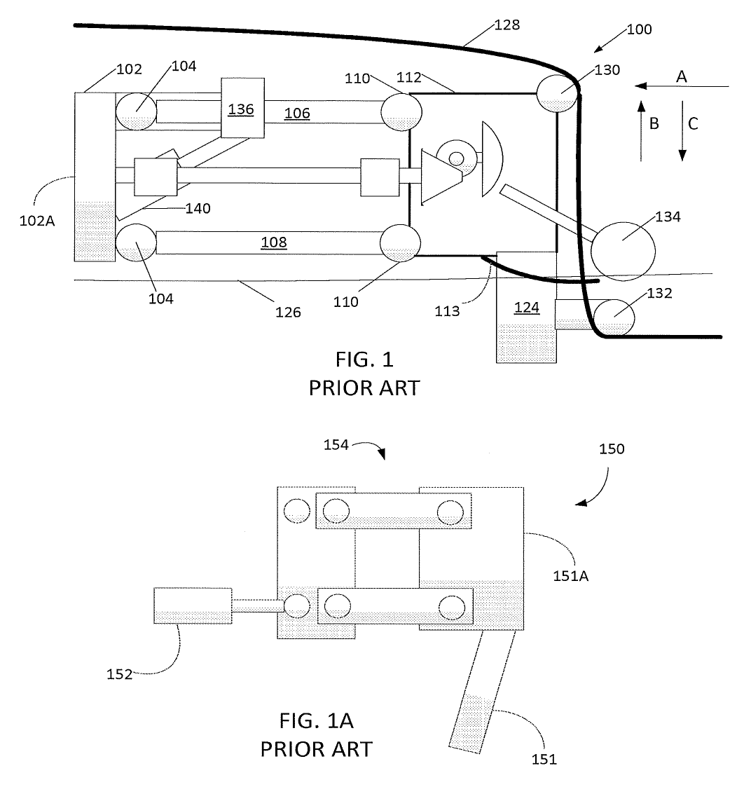

Vibratory plows often include a four-bar linkage that operably couples to a towing machine and allows the shaker box and plow assembly to move in a generally vertical direction relative to the towing machine as the towing machine pulls the plow through the ground by applying a force thereto in a generally horizontal direction. Attention is directed now to FIG. 1, which shows a typical prior art vibratory plow assembly 100 mounted to a rear end 102 of a towing machine 102A. The plow assembly 100 includes a four-bar linkage comprising pivot joints 104, an upper link (or pull arm) 106, a lower link (or pull arm) 108, and rear pivots 110. The plow assembly 100 further includes a shaker box 112, a tamping foot 113, a plow blade 124, an upper pulley 130, a guide 132, a rear wheel 134, a lift bracket 136, and a hydraulic lift cylinder 140.

The towing machine 102A may be a tractor, a dozer, or any machine capable of pulling the plow assembly 100 in a generally horizontal direction A parallel to a ground 126 when the plow assembly 100 is in a lowered position, as shown in FIG. 1, such that the plow blade 124 is at least partially beneath the top surface of the ground 126. As the towing machine 102A travels in the direction A, so does the plow assembly 100, which, in turn, causes the plow blade 124 to be dragged through the ground 126. The blade 124, as is known, consequently forms a narrow groove within the ground 126. The tamping foot 113, which controls the position of the plow assembly 100 relative to the ground 126, is used to maintain the depth of the groove.

As shown in FIG. 1, a utility line 128 (such as a cable, a small diameter pipe, or the like) may be fed over the pulley 130 and down into the groove formed by the plow blade 124. The lower guide 132, which is attached to the back of the plow blade 124, facilitates the positioning of the cable 128 within the groove below the top surface of the ground 126. The rear wheel 134 travels on the ground 126 and, along with the tamping foot 113, maintains the position of the plow blade 124. The rear wheel 134 may also travel over and close the groove formed by the plow blade 124 once the cable 128 has been laid therein.

As can be seen in FIG. 1, the shaker box 112 is coupled to the plow blade 124 and the upper and lower links 106, 108, respectively. The shaker box 112 is illustrated with an internal rotating mechanism that includes gears and weights, as is well known in the art, arranged to generate forces primarily in vertical directions B and C. This rotating mechanism is typically powered by a hydraulic motor. The purpose of the shaker box 112 is to lift the plow blade 124 a short distance in the direction B and to then drive the plow blade 124 back down in the direction C. This displacement of the plow blade 124 in the upward direction B followed by the downward movement of the plow blade 124 in the direction C is known to reduce the drawbar (or pull/draft) force required to move the plow blade 124 through the soil 126 in the direction A.

The four-bar linkage that connects the plow assembly 100 to the towing machine 102A may also be used to lift the plow assembly 100 for transport. In the transport mode, the plow blade 124 is raised above the ground 126 and is not in contact therewith. The lifting function is provided in the plow assembly 100 in FIG. 1 by the lift cylinder 140 and the lift bracket 136 that engages the upper link 106. When the hydraulic cylinder 140 is extended, it forces the lift bracket 136 to push on the upper link 106 and to rotate about pivots 104 (in a counter-clockwise direction in FIG. 1), which causes the plow assembly 100 to be lifted off the ground 126 for transport.

Another configuration for a lifting mechanism is illustrated in FIG. 1A with reference to plow assembly 150 having a plow blade 151 and an oscillating mechanism (e.g., a shaker box) 151A. In this configuration, a lift cylinder 152 is attached to the frame 154 that is pivotally coupled at its top to a towing machine (not shown). When the cylinder 152 extends, the frame 154 pivots (in a counter-clockwise direction in FIG. 1A) to lift the plow blade 151 out of the ground by the lifting and rotating motion.

As noted, the force required to pull through the ground in a horizontal direction a plow blade that is oscillating in the vertical direction is less than the force required to pull a static plow blade through the ground in the horizontal direction. For this reason, vibratory plows have become commonplace, as it is desirable to pull the plow blade through the ground with increased efficiency. It will be appreciated that a reduction in the drawbar force required to pull a plow blade and create a groove of the desired width and depth yields numerous benefits; for example, where the required drawbar force is reduced, a less powerful towing machine may be employed, which may result in cost savings. Similarly, for example, reduction in the required drawbar force may allow utility lines to be installed in hardened soil in a more timely fashion.

While oscillating mechanisms used in vibratory plows are advantageous overall, they also have some unintended consequences. Chief among these is the transfer of the vibrations from the plow assembly to the towing vehicle. As will be appreciated, because the towing machine is physically coupled to the plow assembly having the shaker box, when the shaker box oscillates to cause the plow assembly to vibrate, some of the vibrations are unintentionally and inherently transferred to the towing vehicle. These vibrations may result in unnecessary wear and tear to the components of the towing machine, and can, in some instances, cause discomfort to the operator of the towing machine.

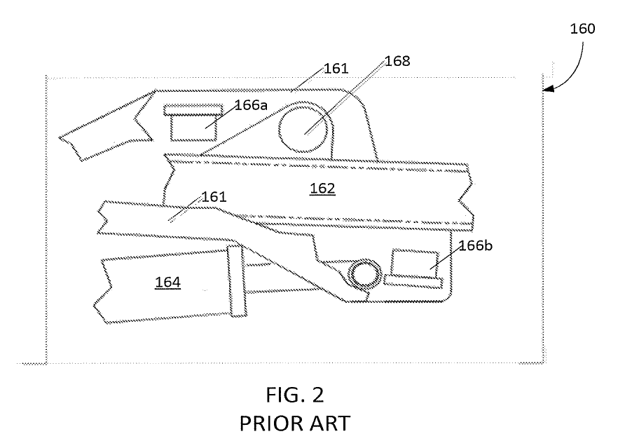

To minimize the transfer of the vibrations from the plow assembly to the towing machine, the prior art plows generally include some type of energy absorptive members in their lifting mechanism. One exemplary prior art plow, sold by Applicant Vermeer Manufacturing Corporation as model VP750, and described generally in U.S. Patent Application Publication No. 2010/0044061 which is hereby incorporated by reference in its entirety, is shown in FIGS. 2 and 2B as having a pull arm junction 160, a lift bracket 161, and an upper pull arm or link 162 (the lift bracket 161 is shown cut away to better show the components). The lift bracket 161 and the upper pull arm 162 are each pivotally connected to the frame of the towing machine at a common mounting location. A hydraulic cylinder 164 may be extended to cause the lift bracket 161 and the upper pull arm 162 to rotate and pull the plow blade out of the ground for transport of the plow. As can be seen, in this plow, dampeners 168 are mounted on each side of the upper link 162 (see FIG. 2B) with brackets 169, and an upper elastomeric bumper 166a and a lower elastomeric bumper 166b (See FIG. 2) limit excessive displacement of the plow relative to the lift bracket 161. In this example, any relative movement of the shaker box (not shown) and the upper pull arm 162 with respect to the lift bracket 161 results in deflection or deformation of the dampeners 168, and excessive relative movement results in deflection and deformation of the elastomeric bumpers 166a and 166b. The deflection and/or deformation of either the dampeners 168 or the elastomeric bumpers 166a, 166b dampens this relative movement, and reduces the vibration energy transferred to the towing machine. There is 1.5 inches of allowable displacement of the upper pull arm 162 between the upper elastomeric bumper 166a and the lower elastomeric bumper 166b.

Another exemplary prior art vibratory plow, which has a lifting mechanism similar to that shown in FIG. 1A, is described in U.S. Pat. No. 3,618,237. This prior art plow includes dampening components (referred to therein as the “elastic torque cushioning elements”) at the pivot points. Movement of the shaker box relative to the towing machine results in deflection and deformation of the elastomeric dampeners, which absorb much of the vibrations that would otherwise be transferred from the plow to the towing machine.

U.S. Pat. No. 6,244,355 shows another exemplary prior art vibratory plow that has a lifting mechanism similar to that shown in FIG. 1. This prior art plow is mounted to the towing machine via an isolating mount having resilient members. Movement of the shaker box relative to the towing machine results in deformation and deflection of the resilient members of the isolating mount, which serve to reduce the vibrations transferred from the vibrating plow to the towing machine.

Yet another prior system 170, sold by Applicant Vermeer Manufacturing Corporation as model LM 42 and having a lifting mechanism similar to that illustrated in FIG. 1A, is shown in FIG. 2A. This vibratory plow 170 has a shaker box 172, an upper link 176, and a lower link 178. The plow 170 is shown as having two matched upper and lower springs 174A and 174B, respectively. The upper spring 174A supports the weight of the shaker box 172 and the plow assembly in a transport position by reacting against the upper link 176, and the lower spring 174B restricts upward movement of the shaker box 172 and the plow assembly relative to the towing machine by reacting against the lower link 178. The coiled upper and lower springs 174A and 174B are not dampeners in that the springs 174A and 174B, unlike energy absorptive members (such as elastomeric bumpers) used in the other prior art plow systems discussed above, do not dissipate any energy (or dissipate only an insignificant amount of energy).

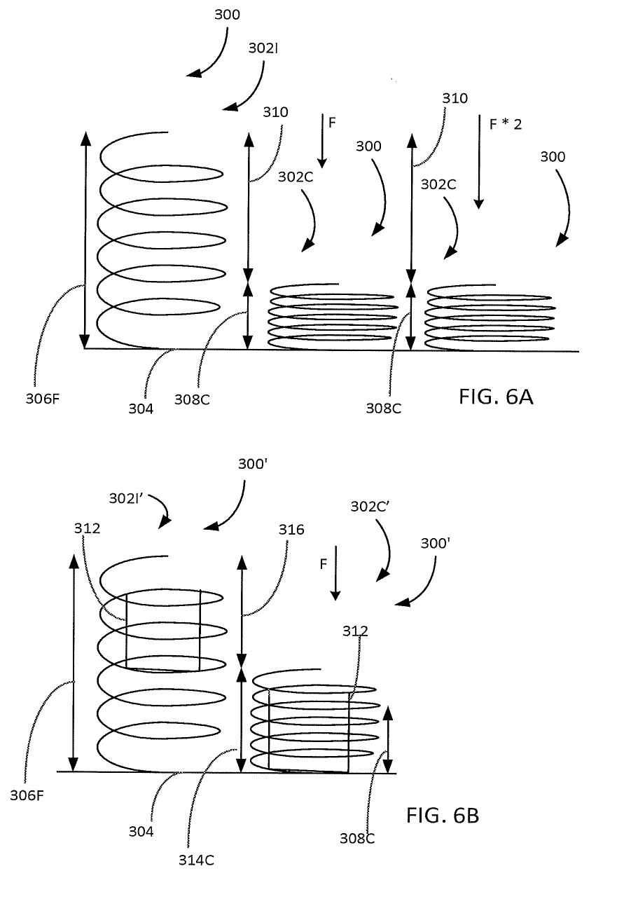

Attention is directed now to FIG. 6A-6B, with reference to which Applicant, acting as his own lexicographer herein, defines the term “undampened” (or “undamped”) and “undampened movement.” FIG. 6A shows a free standing spring 300 in an initial position 3021, and a contracted position 302C after a force F is applied thereto in a generally vertical direction. As can be seen, the free length of the spring 300 (i.e., its height as measured from ground 304 when no external force is being applied thereto) is 306F, and when the force F is applied to the spring 300, the length of the spring 300 in its contracted position 302C becomes 308C. Assume that the force F applied to compress the spring 300 in the contracted position 302C is such that it causes the spring 300 to act as a solid (i.e., a non-resilient) member. That is, even if the force F is increased (e.g., doubled), the length of the spring 300 remains the same (i.e., length 308C), as shown in FIG. 6A. The displacement 310 of the spring 300 from its initial position 3021 to the contracted position 302C (i.e., the difference between the length 306F of the spring 300 when no external force is applied thereto and the length 308C of the spring 300 when it is fully compressed by the application of the force F) is what Applicant refers to herein as the undampened displacement or movement of the spring 300.

Consider now FIG. 6B which shows a spring 300′. The spring 300′ is the same as the spring 300 except that the spring 300′ has an energy absorptive member (e.g., an elastomeric member or dampener) 312 installed therein to limit the movement of the spring 300′ in the vertical direction. Alternatively, the energy absorptive member 312 may be installed near (e.g., at one side) of the spring 300′ to limit the vertical movement of the spring 300′, or a hard stop may instead be used instead of, or in parallel with, the absorptive member 312. When the force F is applied, and before the spring 300′ can contract to its fully compressed length 308C as in FIG. 6A, the energy absorptive member 312 contacts the ground 304 and, to a large extent, prevents further movement of the spring 300′ in the vertical (i.e., downward) direction. In FIG. 6B, the length of the spring 300′ in the compressed position 302C′ is shown as 314C. The displacement 316, i.e., the distance that the spring 300′ travels from its initial position 3021′ to its contracted position 302C′, when the energy absorptive member 312 contacts the ground 304, is what Applicant refers to herein as the undampened movement of the spring 300′.

Put succinctly, then, Applicant defines the term “undamped movement” of a spring to mean that displacement of a spring which occurs before the spring acts as a solid (i.e. non-resilient) member and before an absorptive member associated with (e.g., installed within or near) the spring and configured to limit the travel of the spring contacts the ground or another surface. It will further be appreciated that the term “absorptive member”, as used herein, encompasses different types of dampeners (such as elastomeric bumpers, hydraulic dampeners, or the like), but excludes springs.

Attention is now directed back to FIG. 2A. In this example, the upper spring 174A and the lower spring 174B may each have a free length of about 12 inches, a spring rate of about 442 lbs./inch, and a solid height (when fully compressed) of about 7.5 inches. The lower spring 174B, as configured in the plow 170, may have a static length of about 8.56 inches in its normal operating position; this means that the lower spring 174B may only be further compressed by about one inch before it reaches its solid height of about 7.5 inches. This undampened movement of the lower spring 174B of about one inch may correspond to about two inches of upward displacement of the shaker box 172 and the plow blade. That is, the upper spring 174A and the lower spring 174B allow the shaker box 172 to move approximately two inches from its normal operating position, at which point, the lower spring 174B is fully compressed and acts as a solid member. Applicant is unaware of any prior art vibratory plow that allows for greater undampened movement of its coil springs. It will be appreciated that once the lower spring 174B fully compresses and acts as a solid member, the resulting upward forces are transferred to the entire machine (and dampened eventually by the tires). Applicant's static assessment and testing of the spring loads shows that the shaker box 172 would need to generate about 440 lbs. of force in order to effectuate this vertical displacement of two inches of the plow blade.

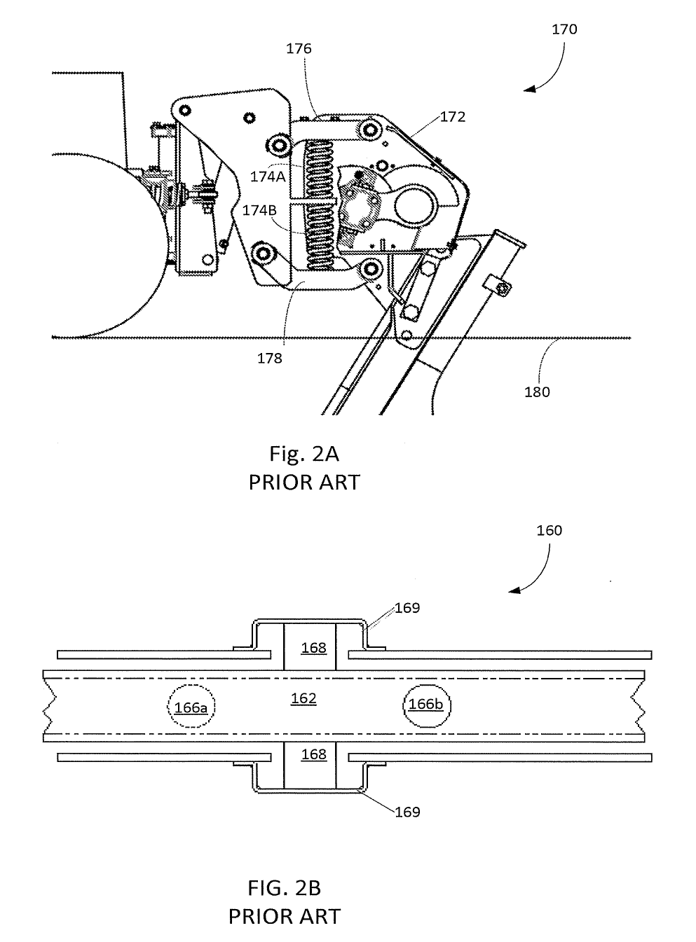

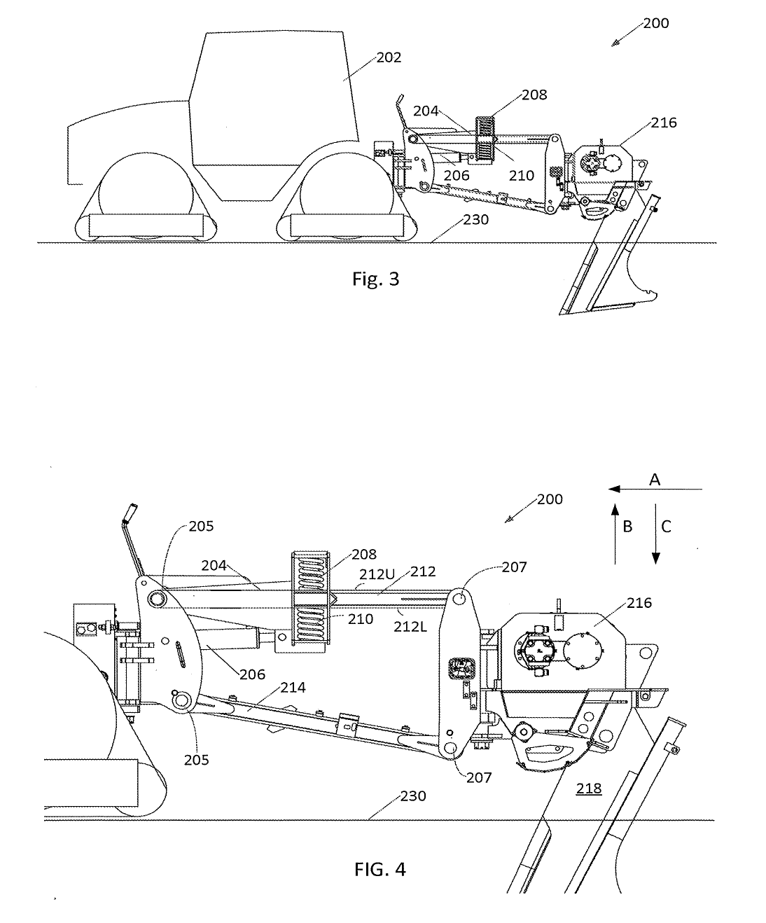

Focus is directed now to FIGS. 3 and 4, which show a vibratory plow assembly 200 according to an embodiment of the present invention. The vibratory plow assembly 200 may be coupled to a towing machine 202, which may be tractor as shown, or any other machine capable of towing the plow assembly 200 in a generally horizontal direction. The plow assembly 200 may include a lift bracket 204, front pivots 205, a hydraulic lift cylinder 206, rear joints 207, an upper spring 208, a lower spring 210, an upper link (or pull arm) 212, a lower link (or pull arm) 214, a shaker box 216, and a plow blade 218.

The lift bracket 204 may be mounted to the rear of the towing machine 202. The plow assembly 200 is shown in FIGS. 3-4 in a lowered position such that the blade 218 is at least partially underneath the top surface of the ground 230. The plow assembly 200 may be raised for transport in a transport position (not specifically shown) where the blade 218 is above the ground 230 by using the lift bracket 204 and the lift cylinder 206. Specifically, when the lift cylinder 206 is extended, the lift bracket 204 may pivot (in a counter clockwise direction in FIGS. 3-4) at the front pivots 205 and lift the plow blade 218 out of the ground 230 by the lifting and rotating motion.

The shaker box 216 assembly may be suspended from the upper link 212 and the lower link 214, and the blade 218 may be operably coupled to the shaker box 216. The upper spring 208 may be mounted at an upper side 212U of the upper link 212 and the lower spring 210 may be mounted at a lower side 212L of the upper link 212. The lift bracket 204 and the upper link 212 may each be coupled to the frame at the front pivots 204. The shaker box 216 may be configured to oscillate primarily in a vertical direction (i.e., directions B and C in FIG. 4). When the shaker box 216, from its normal operating position (i.e., a “baseline” or “initial” position when the shaker box 216 is at rest and no vibratory energy is being generated), travels vertically in the direction B, it may cause the blade 218 to also travel in the direction B. Movement of the shaker box 216 in the direction B may cause the upper link 212 to rotate at the front pivots 205 (in a counter clockwise direction in FIGS. 3-4), which may, in turn, cause the upper link 212 to push the upper spring 208 in the direction B and compress. Similarly, movement of the shaker box 216 from the baseline position in the direction C may cause the upper link 212 to rotate at the front pivots 205 (in a clockwise direction in FIGS. 3-4), and the upper link 212 may resultantly push the lower spring 210 in the direction C and compress the lower spring 210. The upper spring 208 and the lower spring 210, therefore, may temporarily store the energy generated by the vibrating upper link 212. It may be preferable, at least in some embodiments, to configure the upper spring 208 and the lower spring 210 to have relatively low hysteresis so that virtually all (or most) of the energy stored in the springs 208, 210 during loading is recovered during unloading.

In one particular embodiment, the upper spring 208 comprises 5160H chromium steel and has a free length of about 8.75 inches, such as the spring provided at Stock No. 4094 by Century Spring Corporation. The spring rate of the upper spring 208 in this embodiment is about 1669 lbs./inch. Of course, the upper spring 208 may also be another type of spring, and its free length and spring rate may be differently configured to suit the requirements of the particular application. The static length of the upper spring 208, when installed in the plow 200 as shown in FIGS. 3-5, may be approximately 8.15 inches, and the solid length of the upper spring 208 (when fully compressed) may be about 5.03 inches.

The lower spring 210, in this embodiment 200, may have a free length of about 9 inches, whereas the static length of the lower spring 210, when installed in the plow 200 as shown in FIGS. 3-5, may be approximately 7.44 inches. The spring rate of the lower spring 210 may be about 3,000 lbs./inch, a little less than twice that of the upper spring 208. Applicant, during testing, discovered that for some applications, if the lower spring 210 had a lower spring rate (e.g., 1669 lbs./inch akin to the upper spring 208), the ability of the plow 200 to be put in a transport position was adversely affected. Put differently, configuring the lower spring 210 to have a relatively higher spring rate may facilitate the pulling of the plow blade 218 out of the ground 230 for transport. It is to be understood that other springs, each having their own characteristic free, static, and solid lengths, could be employed for the upper spring 208 and/or the lower spring 210 and still be within the scope of the present system, so long as they provide for an undampened travel range commensurate with that of the shaker box 216 disclosed herein.

Theoretically, if the shaker box 216 generates sufficient force in the vertical direction B, the upper spring 208 may compress from its static length in the system 200 of 8.153 inches to its solid length of about 5.03 inches. This undampened movement of about 3.1 inches of the upper spring 208 may correspond to about a 6 inch displacement of the shaker box 216 (and the plow blade 218) in the vertical direction B from its normal operating (i.e., baseline) position. However, as discussed below, because the upper spring 208 may have an absorptive member 220 installed therein, the maximum allowable undampened movement of the upper spring 208, in one embodiment, may be about 1.55 inches—when the upper spring 208 is about 6.6 inches in length (i.e., static length 8.153 inches-1.55 inches of undampened displacement=resulting length of 6.6 inches).

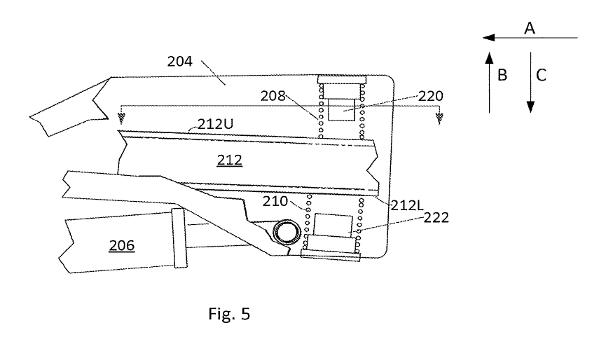

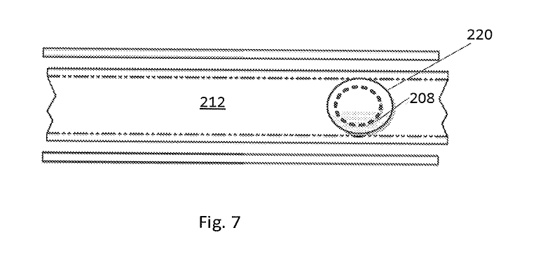

FIGS. 5 and 7 show the absorptive members 220, 222 in additional detail. As can be seen, the upper absorptive member 220 may be installed within the upper coil spring 208, and a lower absorptive member 222 may be installed within the lower coil spring 210. Alternatively, the absorptive members 220, 222 may have been installed near (e.g., at one side) of the springs 208, 210, respectively, to limit the movement of the springs 208, 210 in the vertical direction. The upper absorptive member 220 and the lower absorptive member 222, in this embodiment, may be an elastomeric member; however, other appropriate dampeners may also be utilized.

Each of the upper spring 208 and the lower spring 210 may be, and may remain, in direct contact with the upper link 212. Thus, when the shaker box 216 exerts a sufficient force in the upward direction B and causes the upper link 212 to rotate, both the upper spring 208 and the lower spring 210 may be impacted. Specifically, when the shaker box 216 exerts a sufficient force in the upward direction B, the upper link 212 may rotate (in a counter clockwise direction in FIGS. 3-4) and cause the upper spring 208 to compress from its static length of 8.153 inches to about 6.6 inches, at which point, the upper bumper 220 may contact the upper side 212U of the upper link 212 and prevent further undampened movement of the upper spring 208. Thus, the undampened displacement of the upper spring 208 may equal about 1.55 inches. At the same time, the lower spring 210 which is also coupled to the upper pull arm 212, may extend from its static length of 7.44 inches to its free length about 9 inches.

This undampened displacement of the upper spring 208 of about 1.55 inches may correspond to a displacement of the shaker box 212 and the blade 218 of about 3.1 inches in the direction B from the normal operating position. Applicant's tests and static analysis shows that the shaker box 216 would need to produce approximately 3,500 lbs. of upward force, as measured at the springs 208, 210, to create this displacement, which corresponds to approximately 1750 lbs., as measured at the shaker box 216, to yield this displacement of about 3.1 inches in the vertical direction. It will be appreciated from the discussion herein that in the entire range of travel described above (i.e., in the range of travel that begins with the upper spring 208 being in its normal operating position to when the upper spring 208 contracts by about 1.55 inches before the engagement of the absorptive members 220, 222, which corresponds to a displacement of the shaker box 216 and the plow blade 218 of about 3.1 inches), the movement of the upper pull arm 212, and the shaker box 216 and the plow blade 218, is undampened. As noted above, Applicant is unware of any prior art vibratory plow that allows for an undampened displacement of the shaker box 216 and the plow blade 218 of more than two inches.

Thus, it will be appreciated that in both the prior art and in the particular embodiment of the invention described above, absorptive members (e.g., elastomeric bumpers 220, 222) are used to absorb vibrations generated by the oscillating mechanism (e.g., shaker box 216) so as to curtail the transfer of these vibrations to the towing machine. The prior art, however, fails to appreciate that the dampening components adversely affect the productivity of the plow if they are brought into play to limit the movement of the shaker box 216 and the blade 218. In the particular embodiment shown in FIGS. 3-5 and discussed above, the dampening components (i.e., bumpers 220, 222) do not engage until there has been an undampened displacement of about 3.1 inches of the shaker box 216. That is, the described embodiment 200 allows for greater undampened displacement of the springs 208, 210 (and resultantly, of the upper pull arm 212, the shaker box 216, and the plow blade 218) than any other prior art vibratory plow known to Applicant.

This greater range of undampened displacement has yielded a highly beneficial result. Specifically, Applicant, via field and lab testing, determined that increasing the undampened range of displacement of the plow 200 in the stated fashion decreased the drawbar pull required to pull the plow in the direction A by about 14%. This result is highly surprising because the prior art does not indicate or even imply that increasing the range of travel of the springs (e.g., upper spring 208) before the dampening components engage would have any effect, let alone such a desirable effect, on the drawbar pull required to pull the plow 200 in the horizontal direction.

Applicant's static analysis shows that when the upper spring is compressed to about 6.6 inches, the cumulative force of the upper and lower springs 208, 210 is about 3,500 lbs.; that is, the shaker box 216 needs to generate approximately 3,500 lbs. of upward force, as measured at the springs 208, 210, to cause the upper spring 208 to travel about 1.55 inches without any dampening. This 3,500 lbs. of upward force as measured at the springs 208, 210 corresponds to about 1,750 lbs. of upward force as measured at the shaker box 216. Put differently, the shaker box 216, in the embodiment described in FIGS. 3-5, would need to produce about 1,750 lbs. of upward force, as measured at the shaker box 216, to cause the upper spring 208 to compress by 1.55 inches and allow the shaker box assembly 216 to travel about 3.1 inches upward.

Many different arrangements of the various components depicted, as well as components not shown, are possible without departing from the spirit and scope of the present invention. For example, while Applicant describes the lower spring 210 as having a higher spring rate than the upper spring 208, in some embodiments, the spring rate of the upper spring may be equal to or even greater than the spring rate of the lower spring 210. Similarly, for example, Applicant identifies certain types of springs herein only to describe a particular embodiment; the skilled artisan will readily appreciate that different springs may be employed in line with the requirements of the particular application. For instance, the upper spring 208 may comprise two (or more) springs that collectively have the effective spring rate of about 1669 lbs./inch. Alternative, or in addition, the lower spring 210 may comprise two (or more) springs that collectively have the effective spring rate of about 3,000 lbs./inch.

The skilled artisan will also appreciate that the embodiment described in FIGS. 3-5 and 7 is merely exemplary and is not intended to be limiting. Indeed, the undampened range of travel of other prior art plows may also be increased to decrease the drawbar force required to pull these plows in a horizontal direction. For example, the undampened range of travel of the springs 174A, 174B of the prior art plow sold by Applicant as model LM 42 and shown in FIG. 2A may be increased to decrease the drawbar force required to pull this prior art plow in a horizontal direction. Further, the springs need not necessarily be mounted on either side of the pull arm; so long as one spring compresses when the pull arm moves upwards and the other spring compresses when the pull arm moves downwards, other arrangements of the springs (e.g., in-line) may be employed with appropriately shaped pull arms and lift brackets. Moreover, while Applicant describes the shaker box 216 and blade 218 of the embodiment 200 as having an undampened displacement of 3.1 inches in a vertical direction (e.g., direction B or direction C) from a baseline position, it will be readily appreciated that any undampened displacement of the shaker box 216 and the plow 218 of greater than two inches (e.g., 2.1 inches, 2.5 inches, 2.7 inches, 3.3 inches, 3.8 inches, et cetera) would increase the efficiency of the plow 200 as compared to prior art vibratory plows.

Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described. Terms such as up, down, left, and right, et cetera, are used to describe the invention in a typical configuration or orientation and are not independently limiting.

The invention claimed is:

1. A vibratory plow comprising:
a lift bracket;
an upper link and a lower link; the upper link being operably coupled to the lift bracket;
an upper spring having an upper energy absorptive member associated therewith; the upper spring being adjacent the upper link; the upper spring and the upper energy absorptive member collectively configured to limit relative movement of the upper link with respect to the lift bracket in a first direction;
a lower spring having a lower energy absorptive member associated therewith; the lower spring being adjacent the upper link; the lower spring and the lower energy absorptive member collectively configured to limit relative movement of the upper link with respect to the lift bracket in a second direction opposite the first direction;
a shaker box; the shaker box operably coupled to the upper link and the lower link; and
a plow blade; the plow blade being attached to the shaker box;
wherein the shaker box is configured to travel from an initial baseline position a first distance in the first direction before the upper spring compresses to such as extent so as to enable the upper energy absorptive member to dampen the movement of the shaker box;
wherein the first distance is greater than two inches.

2. The vibratory plow of claim 1, wherein the first distance is about 3.1 inches.

3. The vibratory plow of claim 1, wherein an undampened movement of the upper spring is about half the first distance.

4. The vibratory plow of claim 1, wherein a spring rate of the lower spring is greater than a spring rate of the upper spring.

5. The vibratory plow of claim 1, wherein a spring selected from the group consisting of the upper spring and the lower spring comprises a plurality of springs coupled in parallel.

6. The vibratory plow of claim 1, wherein the upper energy absorptive member is a dampener.

7. The vibratory plow of claim 6, wherein the dampener is an elastomeric dampener installed within the upper spring.

8. The vibratory plow of claim 1, wherein:
the upper energy absorptive member is an upper elastomeric dampener installed within the upper spring; and
the lower energy absorptive member is a lower elastomeric dampener installed within the lower spring.

9. A linkage system for use with a vibratory plow, the linkage system comprising:
a vibrator tool assembly;
a pull arm for coupling a work machine and the vibrator tool assembly;
a lift bracket;
a first spring having a first energy absorptive member associated therewith;
a second spring having a second energy absorptive member associated therewith;
wherein the first spring and the first energy absorptive member collectively limit relative movement of the pull arm with respect to the lift bracket in a first direction;
wherein the second spring and the second energy absorptive member collectively limit relative movement of the pull arm with respect to the lift bracket in a second direction, the second direction being opposite the first direction;
wherein the pull arm is configured to allow the vibrator tool assembly to travel a first distance relative to the lift bracket from a static baseline position;
wherein the first distance is greater than two inches;
wherein the movement of the vibrator tool assembly to cover the first distance is undampened.

10. The linkage system of claim 9, wherein the first spring is upwardly adjacent the pull arm and the second spring is downwardly adjacent the pull arm.

11. The linkage system of claim 9, wherein the first spring has a lower spring rate than the second spring.

12. The linkage system of claim 9, wherein:
a spring rate of the first spring is about 1,669 lbs./inch; and
a spring rate of the second spring is about 3,000 lbs./inch.

13. The linkage system of claim 9, wherein the vibratory tool assembly comprises a shaker box.

14. The linkage system of claim 13, wherein a plow blade is attached to the shaker box.

15. A work machine comprising:
a towing apparatus; and
a vibratory plow, comprising:
a lift bracket;
an upper link and a lower link; the upper link having a top side and a bottom side; the upper link being operably coupled to the lift bracket;
an upper spring having an upper energy absorptive member associated therewith; the upper spring being adjacent the upper link and in contact with the top side; the upper spring and the upper energy absorptive member collectively configured to limit the relative movement of the upper link with respect to the lift bracket in a first direction;
a lower spring having a lower energy absorptive member associated therewith; the lower spring being adjacent the upper link and in contact with the bottom side; the lower spring and the lower energy absorptive member collectively configured to limit the relative movement of the upper link with respect to the lift bracket in a second direction opposite the first direction;
a shaker box; the shaker box operably coupled to the upper link and the lower link; and
a plow blade; the plow blade being attached to the shaker box;
wherein the shaker box is configured to travel from an initial baseline position a first distance in the first direction before the upper spring compresses to such as extent so as to enable the upper energy absorptive member to engage the upper link;
wherein the first distance is greater than two inches;
wherein the vibratory plow is coupled to the towing apparatus.

16. The work machine of claim 15, wherein the towing apparatus is a tractor.

17. The work machine of claim 15, wherein:
the upper energy absorptive member is an upper dampener installed within the upper spring; and
the lower energy absorptive member is a lower dampener installed within the lower spring.

18. A method of increasing an efficiency of a vibratory plow by decreasing a drawbar force required to pull a blade of the plow through a ground, the method comprising steps:
providing a towing machine;
providing a vibratory plow, comprising:
a lift bracket;
a pull arm;
a spring; and
an oscillating mechanism having the blade operably coupled thereto;
wherein the pull arm is configured to move a first distance relative to the lift bracket in a first direction before an absorptive member associated with the spring contacts the pull arm;
wherein the first distance is greater than two inches.

19. The method of claim 18, wherein the first distance is about three inches.
